(19) United States
(12) Patent Application Publication
(10) Pub. No.: US 2018/0301935 A1
(43) Pub. Date: Oct. 18, 2018

(54) POWER RECEPTION DEVICE, ELECTRONIC APPARATUS, AND POWER SUPPLY SYSTEM

(71) Applicant: SHARP KABUSHIKI KAISHA, Sakai City, Osaka (JP)

(72) Inventor: HIROKAZU KOBAYASHI, Sakai City (JP)

(21) Appl. No.: 15/767,317

(22) PCT Filed: Sep. 14, 2016
(86) PCT No.: PCT/JP2016/077089

§ 371 Date: Apr. 10, 2018

(30) Foreign Application Priority Data
Oct. 15, 2015 (JP) 2015-203595

(51) Int. Cl. H02J 50/12; H02J 7/02; H04B 5/00

(52) U.S. Cl. CPC H02J 50/12; H04B 5/0037; H02J 7/025

(57) ABSTRACT

A power reception unit receives power from a power transmission device; a secondary battery stores the power from the power reception unit; and a control unit operates a first functional unit with the power from the secondary battery, supplies the power from the power reception unit to a second functional unit in a case that the secondary battery stores the power from the power reception unit, and stop the supply of the power from the power reception unit to the second functional unit in a case that the secondary battery does not store the power from the power reception unit. It is possible for the embodiment of the present invention to be realized as a power reception device, an electronic apparatus, or a power supply system.

### TECHNICAL FIELD

The present invention relates to a power reception device, an electronic apparatus, and a power supply system.

Priority is claimed on Japanese Patent Application No. 2015-203595, filed Oct. 15, 2015, the content of which is incorporated herein by reference.

### BACKGROUND ART

With the development of wireless information technology, small electronic apparatuses such as mobile phones are becoming widespread. An electronic apparatus is carried by a user and power is consumed when the electronic apparatus is used. Thus, an operation for supplying electric power may be forced to maintain a function of the electronic apparatus. In recent years, a contactless power supply system capable of supplying power to an electronic apparatus in a contactless (wireless) manner without performing such an operation has attracted attention. The contactless power supply system may also be referred to as a contactless charging system or a contactless power transmission system.

The contactless power supply system includes a power transmission unit incorporated in a charger or the like and a power reception unit incorporated in the electronic apparatus. For example, the contactless power supply system described in Patent Document 1 includes a power transmission module having a power transmission coil, a power reception coil that receives power via electromagnetic induction, and a power reception module having a secondary battery charged with direct current (DC) power obtained by rectifying the received power, wherein the power reception module includes the secondary battery and a protection circuit that prevents the secondary battery from being excessively discharged. The power reception module includes a switching control unit that performs switching between a storage mode in which a path from the secondary battery to all power supply portions including the protection circuit is shut off and a use mode in which power supply is enabled. Thus, a charged state of the secondary battery can be maintained and the electronic apparatus that consumes the power stored in the secondary battery can operate.

### PRIOR ART DOCUMENT

### Patent Document

[Patent Document 1]

Japanese Unexamined Patent Application, First Publication No. 2014-54059

### SUMMARY OF INVENTION

### Problem to Be Solved by Invention

However, in the contactless power supply system described in Patent Document 1, a position of the electronic apparatus may deviate from a charging area where power from the power transmission coil can be received during charging. At this time, even though the secondary battery is not charged, the state in which the electronic apparatus consumes the power stored in the secondary battery continues. Alternatively, even after the charging is completed, a state in which the power stored in the secondary battery is consumed in the electronic apparatus continues. As a result, there is a problem in that, when the user wants to use the electronic apparatus, stored power may not be sufficient for the operation of the electronic apparatus.

The present invention has been made in view of the above-described circumstances and provides a power reception device, an electronic apparatus, and a power supply system capable of reliably operating an electronic apparatus with power from a secondary battery.

### Means for Solving the Problems

The present invention is made to solve the above-described problem, and one aspect of the present invention is a power reception device including: a power reception unit that receives power from a power transmission device; a secondary battery that stores the power from the power reception unit; and a control unit that operates a first functional unit with the power from the secondary battery, supplies the power from the power reception unit to a second functional unit in a case that the secondary battery stores the power from the power reception unit, and stops the supply of the power from the power reception unit to the second functional unit in a case that the secondary battery does not store the power from the power reception unit.

### Effect of Invention

According to an aspect of the present invention, it is possible to reliably operate an electronic apparatus with power from a secondary battery.

### BRIEF DESCRIPTION OF DRAWINGS

FIG. 1 is an exterior diagram of a power supply system according to an embodiment of the present invention.

FIG. 2 is a block diagram illustrating a functional configuration of an electronic apparatus according to an embodiment of the present invention.

FIG. 3 is a flowchart illustrating a power supply process according to an embodiment of the present invention.

FIG. 4 is a table illustrating operation states of functional blocks according to each operation state of the electronic apparatus according to an embodiment of the present invention.

### EMBODIMENTS FOR CARRYING OUT INVENTION

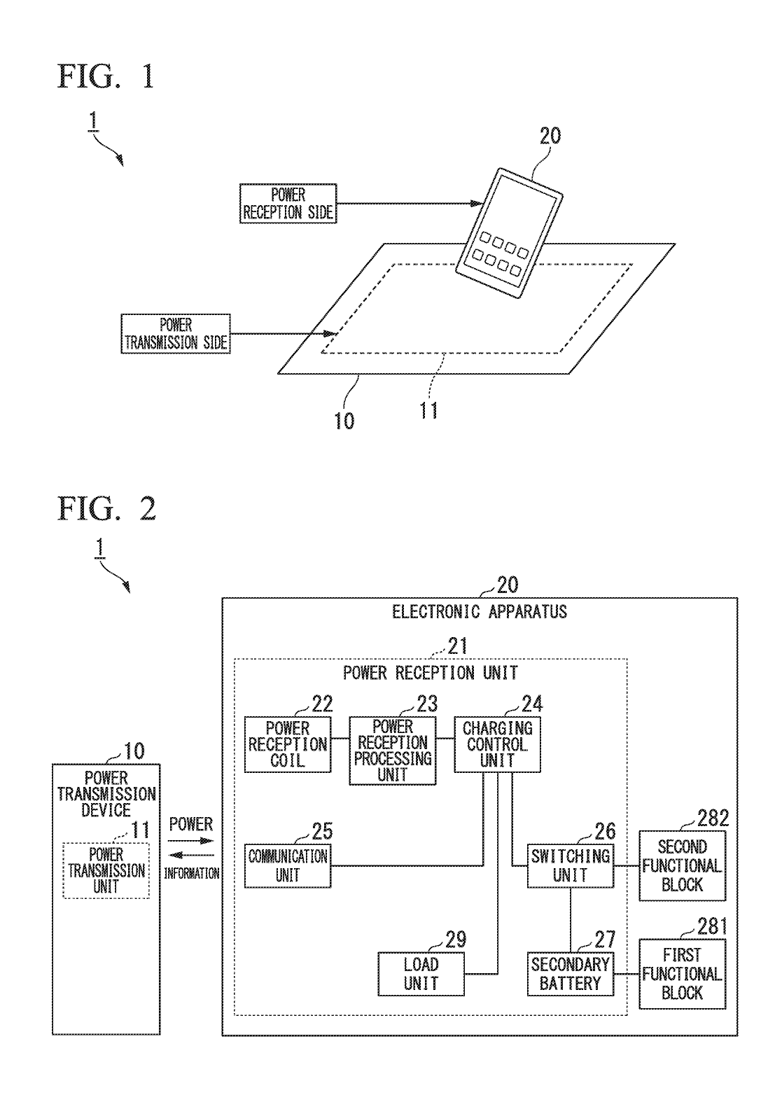

First, an embodiment of the present invention will be described. FIG. 1 is an exterior diagram of a power supply system 1 according to the present embodiment. In the example illustrated in FIG. 1, the power supply system 1 includes a power transmission device 10 at a power transmission side and an electronic apparatus 20 at a power reception side.

The power transmission device 10 acquires electric power and transmits the acquired power to the electronic apparatus 20. The power transmission device 10 includes, for example, a power generation unit (not illustrated), a power transmission unit 11 that transmits power generated by the power generation unit, a power transmission control unit (not illustrated), and a communication unit (not illustrated).

The power generation unit generates alternating current (AC) power and supplies the generated power to the power transmission unit 11. For example, the power generation unit may include an oscillation circuit that generates an electrical signal of a predetermined frequency (for example, 110 KHz, 6.78 MHz, or the like). For example, a power transmission coil provided in the power transmission unit 11 may be used as a coil constituting the oscillation circuit.

The power transmission unit 11 transmits power from the power generation unit. In the example illustrated in FIG. 1, the power transmission unit 11 includes a power transmission coil through which a current for generating the power supplied from the power generation unit flows.

The strength of the current changes in accordance with the passage of time, and thus the strength of a magnetic field around the power transmission coil changes. That is, power is supplied to the electronic apparatus 20 in a contactless (wireless) manner when the power transmission coil radiates the supplied AC power as electromagnetic waves.

The power transmission control unit controls the transmission of power from the power transmission unit 11. The power transmission control unit authenticates whether or not the power reception unit 21 of the electronic apparatus 20 is an apparatus serving as a power transmission target. For example, a power transmission request signal received from the electronic apparatus 20 is input to the power transmission control unit via the communication unit and it is determined whether or not an apparatus identifier (ID) indicated by the power transmission request signal is the same as any of apparatus

IDs of predetermined power transmission target apparatuses. When it is determined that they are the same, the power transmission control unit determines that an apparatus indicated by the apparatus ID indicated by the power transmission request signal is an apparatus of a power transmission target. If it is determined that they are not the same, the power transmission control unit determines that the apparatus indicated by the apparatus ID indicated by the power transmission request signal is not the apparatus of the power transmission target. Also, data indicating various types of information received from the electronic apparatus 20 is input to the power transmission control unit via the communication unit. The power transmission control unit performs control so that a power transmission level of the power from the power transmission unit 11 becomes a power transmission level corresponding to a power class indicated by a level control signal received from the electronic apparatus 20. Thus, the power transmission control unit may pre-acquire power level information indicating a power level of the power received by the electronic apparatus 20 and acquire a transfer function that is a ratio of the power level to the power transmission level. The acquired transfer function is used to determine the power transmission level by multiplying it by the power level corresponding to the power class.

Also, the power transmission control unit may transmit a notification signal to the electronic apparatus 20 via the communication unit every predetermined time (for example, one second). The notification signal is a signal used for the electronic apparatus 20 to detect the power transmission device 10. The notification signal may include information about the apparatus ID of the power transmission device 10.

The power transmission control unit may receive a response signal from the electronic apparatus 20 via the communication unit as a response to the notification signal. Thereby, the power transmission control unit can detect that the electronic apparatus 20 is located within a communicable range from the power transmission device 10. The power transmission control unit may control the output of radio waves from the communication unit so that the communicable range is equal to or close to a range in which power transmission is possible.

Then, when the response signal from the electronic apparatus 20 is not received during a predetermined period (for example, 10 seconds) or more, the power transmission control unit may stop the transmission of power to the electronic apparatus 20.

The communication unit transmits and receives data indicating various types of information to and from the electronic apparatus 20. The communication unit outputs received data to the power transmission control unit and transmits data input from the power transmission control unit to the electronic apparatus 20. The communication unit may be connected to an antenna that transmits and receives radio waves of a predetermined frequency. As the antenna, the above-described power transmission coil may be used, or a dedicated antenna separate from the power transmission coil may be used. The dedicated antenna may be integrated with the power transmission device 10 or may be a body separate from the power transmission device 10. A frequency (for example, 2.4 GHz) of radio waves transmitted and received by the communication unit is different from a frequency of power transmitted by the power transmission unit 11. Thereby, interference between radio waves to be received and electromagnetic waves due to transmitted power is avoided.

The electronic apparatus 20 receives power transmitted from the power transmission device 10 and consumes the received power. For example, the electronic apparatus 20 may be any of a portable phone (including a so-called smartphone), a tablet terminal device, a personal computer, a game machine, a microphone, a display, a pointing device, and the like. In an example described below, a case in which the electronic apparatus 20 is mainly a portable phone is exemplified.

### Configuration of Electronic Apparatus

Next, a configuration of the electronic apparatus 20 will be described.

FIG. 2 is a block diagram illustrating a functional configuration of the electronic apparatus 20 according to the present embodiment.

In the example illustrated in FIG. 2, the electronic apparatus 20 includes a power reception unit 21, a first functional block 281, and a second functional block 282.

The power reception unit 21 receives power transmitted from the power transmission device 10 and stores (performs charging with) the received power. The power reception unit 21 supplies the power (with which the charging is performed) to the first functional block 281. Also, the power reception unit 21 determines whether or not to supply power to the second functional block 282 and controls whether to supply the received power or whether to supply the stored power when the power is supplied.

The power reception unit 21 includes a power reception coil 22, a power reception processing unit 23, a charging control unit 24, a communication unit 25, a switching unit 26, a secondary battery 27, and a load unit 29.

The power reception coil 22 receives AC power transmitted from the power transmission device 10. Because of a change in the strength of the magnetic field based on the electromagnetic waves from the power transmission device 10 around the power reception coil 22, AC power is generated by electromagnetic induction. The power reception coil 22 further constitutes a resonance circuit in which resonance capacitors (not illustrated) are connected in parallel, and the AC power generated at both ends of the resonance capacitor is supplied to the power reception processing unit 23.

The power reception processing unit 23 includes a rectification circuit that rectifies the AC power from the power reception coil 22 and a regulator that adjusts a voltage of the power from the rectification circuit to a predetermined constant voltage. The predetermined constant voltage is, for example, a voltage that is a predetermined voltage width (for example, 0.5 V) higher than a nominal voltage of the secondary battery 27. The power reception processing unit 23 supplies power whose voltage has been adjusted to the charging control unit 24.

The charging control unit 24 controls charging of the secondary battery 27 with power from the power reception processing unit 23. When the communication unit 25 can communicate with the power transmission device 10 and when an activation instruction (power supply ON) is issued in accordance with the operation of the user, the charging control unit 24 generates a power transmission request signal for requesting the power transmission device 10 to transmit power and transmits the generated power transmission request signal to the power transmission device 10 via the communication unit 25. The power transmission request signal may include an apparatus ID of the electronic apparatus 20. The charging control unit 24 determines that communication with the power transmission device 10 is possible by receiving a notification signal from the power transmission device 10 via the communication unit 25. Also, the charging control unit 24 determines that it is impossible to communicate with the power transmission device 10 when a state in which the notification signal is not received for a predetermined time (for example, 10 seconds) or more continues.

The charging control unit 24 may transmit the power transmission request signal to the power transmission device 10 when it is re-determined that communication with the power transmission device 10 is possible.

The charging control unit 24 may determine the power transmission device 10 that is a communication destination of various types of data on the basis of the notification signal received from the power transmission device 10 via the communication unit 25. For example, if the notification signal includes the information of the apparatus ID of the power transmission device 10, the charging control unit 24 may recognize the power transmission device 10 as a power transmission target apparatus on the basis of the apparatus ID of the power transmission device 10. Also, the charging control unit 24 may receive power from the power transmission device 10 if the power transmission device 10 is recognized to be a predetermined power transmission device and may not receive power from the power transmission device 10 if the power transmission device 10 is not recognized to be a predetermined power transmission device.

After the power transmission device 10 is recognized to be a power transmission target apparatus, the charging control unit 24 transmits a level control signal indicating a predetermined power level to the power transmission device 10 via the communication unit 25.

The charging control unit 24 controls the state of the switching unit 26 and controls charging of the secondary battery 27 with the power received from the power transmission device 10 via the power reception processing unit 23. The charging control unit 24 determines whether or not the state of the secondary battery 27 is full charge. When it is determined that the state of the secondary battery 27 is full charge, the charging control unit 24 does not charge the secondary battery. At this time, the charging control unit 24 causes the switching unit 26 to disconnect the connection between the charging control unit 24 and the secondary battery 27. In the following description, this connection state may be referred to as an OFF state. The charging control unit 24 charges the secondary battery when it is determined that the state of the secondary battery 27 is not full charge. At this time, the charging control unit 24 electrically connects the switching unit 26 between the charging control unit 24 and the secondary battery 27. In the following description, this connection state may be referred to as an ON state. Also, an operation mode in which the secondary battery is charged may be referred to as a charging mode. For example, the charging control unit 24 determines that the state of the secondary battery 27 is full charge when the electromotive force of the secondary battery 27 exceeds a threshold value of the predetermined electromotive force and determines that the state of the secondary battery 27 is not full charge when the electromotive force of the secondary battery 27 is less than or equal to the threshold value of the predetermined electromotive force. The threshold value of the electromotive force is, for example, a voltage higher than the nominal voltage and lower than a constant voltage adjusted by the regulator of the power reception processing unit 23.

When it is determined that the state of the secondary battery 27 is full charge, the charging control unit 24 further determines whether or not the power reception unit 21 can receive power from the power transmission device 10. For example, the charging control unit 24 determines that power supply is possible when the voltage of the power from the rectification circuit of the power reception processing unit 23 is higher than a predetermined operable voltage and determines that power supply is impossible when the voltage of the power from the rectification circuit of the power reception processing unit 23 is less than or equal to the predetermined operable voltage. The operable voltage is, for example, a voltage for enabling operations of the first functional block 281 and the second functional block 282. The operable voltage may be lower than the nominal voltage of the secondary battery 27.

When it is determined that the power reception unit 21 can supply power, the charging control unit 24 supplies the power from the power reception processing unit 23 to the load unit 29. Thereby, the charging control unit 24 causes the load unit 29 to consume power. An operation mode for supplying power to the load unit 29 may be referred to as a power supply mode. When it is determined that the power reception unit 21 cannot supply power, the charging control unit 24 determines that the power supply is completed and stops the supply of power from the power reception processing unit 23 to the load unit 29. Thereafter, when an operation start is indicated by an operation signal generated in accordance with an operation of the user, power is supplied to all or a part of the first functional block 281 or the second functional block 282.

The charging control unit 24 may control a magnitude of power supplied to the load unit 29 (hereinafter, a power level) so that the power level matches a level of power consumed by the load unit 29. A plurality of steps of power levels are preset as steps of a controllable power level (hereinafter referred to as a power class). For example, the charging control unit 24 selects a power class corresponding to a lowest power level among power classes corresponding to power levels higher than the level of power consumed by the load unit 29 within the plurality of steps.

The charging control unit 24 transmits a level control signal indicating the power level corresponding to the selected power class to the power transmission device 10 via the communication unit 25. Thereby, the power level of the power supplied from the power reception processing unit 23 to the charging control unit 24 is controlled so that the power level becomes the indicated power level.

Also, the charging control unit 24 may control the power level of the power to be supplied to the second functional block 282 in accordance with the power level of the power consumed by the second functional block 282. Here, the charging control unit 24 determines whether or not the power supply from the power transmission unit 11 is maintained. For example, if the power level of the power from the power reception processing unit 23 is greater than or equal to the power level of the power consumed by the second functional block 282, the charging control unit 24 determines that the power supply is maintained. In this case, the charging control unit 24 maintains the state of the switching unit 26 electrically connected between the charging control unit 24 and the second functional block 282 and maintains the supply of power from the charging control unit 24 to the second functional block 282. If the power level of the power from the power reception processing unit 23 is lower than the power level of the power consumed by the second functional block 282, the charging control unit 24 determines that the power supply is not maintained. In this case, the charging control unit 24 disconnects the connection of the switching unit 26 between the charging control unit 24 and the secondary battery 27 and stops the supply of power from the charging control unit 24. That is, charging of the secondary battery 27 is stopped. Then, the charging control unit 24 causes the switching unit 26 to be electrically connected between the charging control unit 24 and the secondary battery 27 and causes the power from the secondary battery 27 to be supplied to the second functional block 282.

If the power supply is maintained, for example, if power is supplied in a contactless manner, the power reception coil 22 may be located within a range of the predetermined power supply area. The power supply area is a region where the strength of an electric field from the power transmission coil of the power transmission device 10 is higher than predetermined electric field strength. On the other hand, if the power reception coil 22 is located outside the range of the power supply area, the power supply is not maintained.

Also, the charging control unit 24 may include a dedicated circuit or a microcomputer.

The communication unit 25 receives data indicating various types of information from the charging control unit 24 and transmits the input data to the power transmission device 10 in a wireless or wired manner. If data is wirelessly received, data transmitted with radio waves of a predetermined frequency is received via an antenna. As the antenna, a dedicated antenna may be provided in the communication unit 25, or the power reception coil 22 may be used.

The switching unit 26 includes a member capable of controlling whether to make an electrical connection or disconnection between the charging control unit 24 and the secondary battery 27 and between the secondary battery 27 and the second functional block 282. Such a member is, for example, a switch. When the switching unit 26 is electrically connected between the charging control unit 24 and the secondary battery 27 and turns ON, power from the charging control unit 24 is supplied to the secondary battery 27. When the connection is disconnected and the switching unit 26 turns OFF, the supply of power from the charging control unit 24 to the secondary battery 27 is stopped. When the switching unit 26 is electrically connected between the charging control unit 24 and the second functional block 282 and turns ON, power from the secondary battery 27 is supplied to the second functional block 282. When the connection between the charging control unit 24 and the second functional block 282 is disconnected and the switching unit 26 turns OFF, the supply of power from the secondary battery 27 to the second functional block 282 is stopped.

The secondary battery 27 stores power supplied from the charging control unit 24 via the switching unit 26. Also, the secondary battery 27 supplies the stored power to the second functional block 282 via the switching unit 26. The secondary battery 27 is electrically connected to the first functional block 281 and supplies the stored power to the first functional block. The secondary battery 27 may be, for example, any one of a lithium ion secondary battery, a nickel-cadmium storage battery, and the like.

The first functional block 281 and the second functional block 282 are circuits, elements, and other members that performs some functions of the electronic apparatus 20 by consuming the supplied power. For example, the first functional block 281 that includes a control device such as a main central processing unit (CPU) or a storage medium such as a random access memory (RAM) or a read-only memory (ROM) as a member that performs a necessary minimum function in the electronic apparatus 20. The second functional block 282 that includes a member that performs a function whose operation state does not directly affect the operation of the first functional block 281 as another function. For example, the second functional block 282 includes members such as a liquid crystal display (LCD), a speaker, and a light emitting diode (LED).

The load unit 29 is a circuit, an element, or another member that consumes power from the power reception processing unit 23. The load unit 29 may be, for example, an LCD, an LED, an alarm, or the like. Also, some or all of the components of the second functional block 282 may be used as the load unit 29.

The second functional block 282 may include an operation input unit (not illustrated). The operation input unit generates an operation signal in accordance with an operation performed by the user. In the operation signal, any one of the functions provided in the second functional block 282 may be indicated. The second functional block 282 performs an operation related to the function indicated by the operation signal. At this time, the charging control unit 24 supplies sufficient power to the second functional block 282 via the switching unit 26 so that the function indicated by the operation signal from the operation input unit is performed. If an operation signal indicating the stop of the function is input from the operation input unit, the charging control unit 24 stops the supply of power to the second functional block 282 via the switching unit 26.

Also, as described above, if the state of the secondary battery 27 is full charge and the power reception unit 21 determines that power supply from the power transmission device 10 is impossible, the charging control unit 24 may cause power from the secondary battery 27 to be supplied to the second functional block 282 instead of the power reception processing unit 23. In this case, the charging control unit 24 causes the switching unit 26 to disconnect the connection between the charging control unit 24 and the second functional block 282 to set an OFF state and causes the switching unit 26 to make an electrical connection between the secondary battery 27 and the second functional block 282 to set an ON state.

### Power Supply Process

Next, a power supply process to be performed by the power supply system according to the present embodiment will be described.

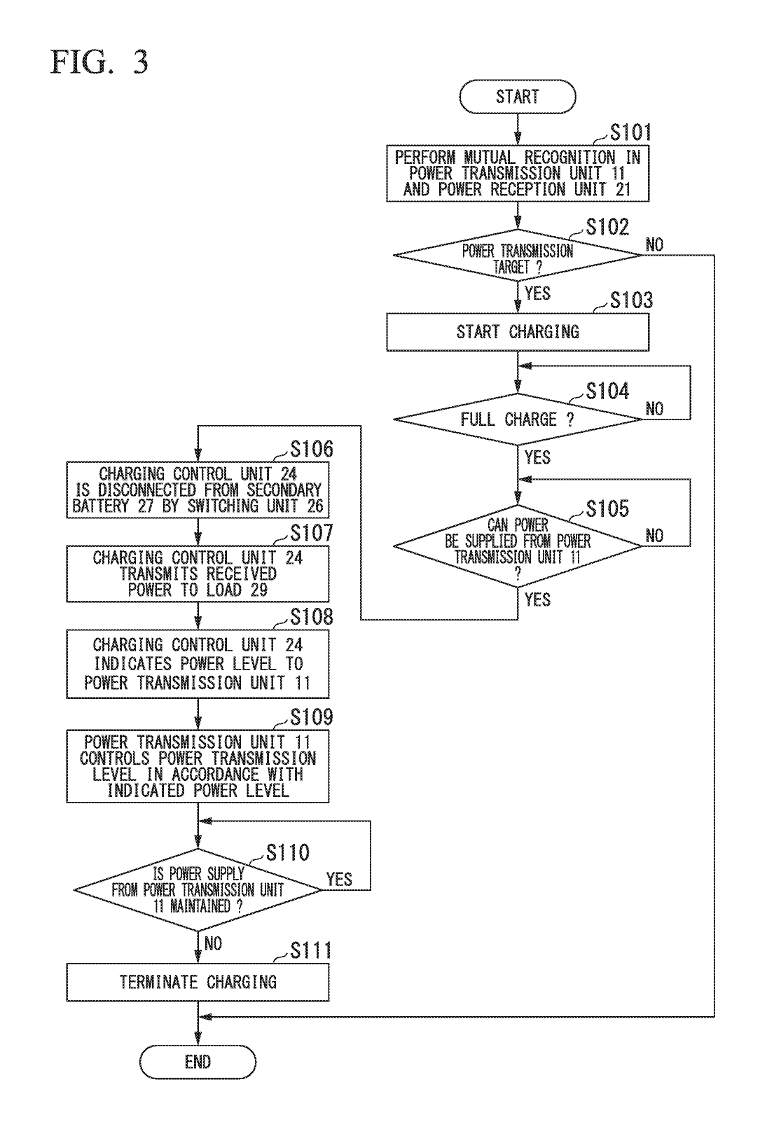

FIG. 3 is a flowchart illustrating a power supply process according to the present embodiment.

(Step S101) The power transmission unit 11 of the power transmission device 10 and the power reception unit 21 of the electronic apparatus 20 are mutually recognized as a power transmission target apparatus and a power reception target apparatus. Here, the charging control unit 24 of the power reception unit 21 recognizes the power transmission device 10 as the power reception target apparatus on the basis of a notification signal from the power transmission control unit of the power transmission unit 11, and transmits recognition confirmation information to the power transmission unit 11. The power transmission control unit of the power transmission unit 11 in the power transmission device 10 recognizes as the power transmission target apparatus on the basis of the recognition confirmation information from the power reception unit 21. Thereafter, the process proceeds to the processing of step S102.

(Step S102) If the power transmission unit 11 recognizes the electronic apparatus 20 as the power transmission target apparatus and the power reception unit 21 recognizes the power transmission device 10 as the power reception target apparatus (YES in step S102), the process proceeds to step S103. Various types of parameters used for control are exchanged between the power transmission unit 11 and the power reception unit 21 before the processing of step S103. Here, for example, the charging control unit 24 transmits a level control signal indicating a predetermined power level to the power transmission unit 11 and the power transmission control unit of the power transmission unit 11 receives a level control signal from the power reception unit 21. If the power transmission unit 11 does not recognize the electronic apparatus 20 as the power transmission target apparatus or the power reception unit 21 does not recognize the power transmission device 10 as the power reception target apparatus (step S102: NO), the process illustrated in FIG. 3 is terminated.

(Step S103) The power transmission unit 11 starts power transmission by starting power supply to the power transmission coil. The power transmission control unit of the power transmission unit 11 controls the power transmission level on the basis of the level control signal received from the power reception unit 21. On the other hand, the charging control unit 24 of the power reception unit 21 causes the switching unit 26 to electrically connect the switching unit 26 to the secondary battery 27, and starts charging with power received from the power transmission unit 11. Thereafter, the process proceeds to the processing of step S104.

(Step S104) The charging control unit 24 determines whether or not the state of the secondary battery 27 is full charge on the basis of an electromotive force of the secondary battery 27. When the charging control unit 24 determines that the state of the secondary battery 27 is full charge (YES in step S104), the process proceeds to the processing of step S105. When the charging control unit 24 determines that the state of the secondary battery 27 is not full charge (NO in step S104), the processing of step S104 is iterated every predetermined time (for example, one minute).

(Step S105) The charging control unit 24 determines whether or not power can be supplied from the power transmission unit 11 on the basis of a voltage of power from the power reception processing unit 23. When it is determined that power can be supplied (YES in step S105), the process proceeds to step S106. When it is determined that the power supply is impossible (step S105 NO), the processing of step S105 is iterated every predetermined time (for example, one minute).

(Step S106) The charging control unit 24 disconnects the connection between the charging control unit 24 and the secondary battery 27 from the switching unit 26. Thereafter, the process proceeds to the processing of step S107.

(Step S107) The charging control unit 24 supplies power received from the power transmission unit 11 via the power reception processing unit 23 to the load unit 29, and causes the load unit 29 to consume the supplied power. Thereafter, the process proceeds to the processing of step S108.

(Step S108) The charging control unit 24 transmits a level control signal indicating a power class corresponding to a level of power consumed by the load unit 29 to the power transmission unit 11 via the communication unit 25. Thereafter, the process proceeds to the processing of step S109.

(Step S109) The power transmission control unit of the power transmission unit 11 controls a level of power to be transmitted to the power reception unit 21 to a power level corresponding to the power class indicated by the level control signal received from the power reception unit 21. Thereafter, the process proceeds to the processing of step S110.

(Step S110) The charging control unit 24 determines whether or not power supply from the power transmission unit 11 is maintained. When the charging control unit 24 determines that the power supply is maintained (YES in step S110), the power supply to the secondary battery 27 is maintained, i.e., charging is continued, and the process of step S110 is iterated every predetermined time. When the charging control unit 24 determines that the power supply is not maintained (NO in step S110), the process proceeds to step S111.

(Step S111) The charging control unit 24 terminates the supply of power to the secondary battery 27, i.e., the charging. Thereafter, the process illustrated in FIG. 3 is terminated.

### Operation States of Functional Blocks

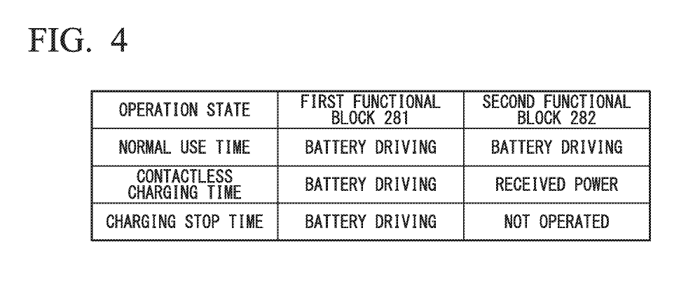

Next, operation states of functional blocks of the electronic apparatus 20 will be described. FIG. 4 is a table illustrating operation states of functional blocks according to each operation state of the electronic apparatus 20 according to the present embodiment.

For a normal use time, the first functional block 281 and the second functional block 282 are operated through battery driving. The normal use time means that the electronic apparatus 20 is operated without receiving power supply from the power transmission device 10 and, for example, its function is performed according to the operation of the second functional block 282. For the normal use time, a case in which the power supply from the power transmission unit 11 is not maintained or a case in which the communication unit 25 cannot communicate with the power transmission device 10 is included. This is because, when communication with the power transmission device 10 cannot be performed, a start, an end, a power level, and the like of power supply are not controlled. In contactless power supply, a case in which power supply is not maintained may correspond to a case in which communication cannot be performed. The battery driving means that an operation is performed by power supplied from the secondary battery 27.

A contactless charging time corresponds to the above-described charging mode. For the contactless charging time, the first functional block 281 is operated through battery driving, and the second functional block 282 is operated with power received from the power transmission unit 11. The first functional block 281 can receive stable power supply from the secondary battery 27 through battery driving.

When charging is stopped, the first functional block 281 is operated through battery driving, and an operation is stopped without supplying power to the second functional block 282. When charging is stopped, the power supply mode in the case where the state of the secondary battery 27 described above is full charge is included. As described above, the first functional block 281 performs an operation related to a necessary minimum function of the electronic apparatus 20 and power stored in the secondary battery 27 is not supplied to the second functional block 282. Because consumption of power stored in the secondary battery 27 is minimized in a state in which the operation of the electronic apparatus 20 is maintained, a situation in which power is insufficient for an operation is avoided as much as possible if the second functional block 282 is re-performed with stored power.

As described above, the electronic apparatus 20 according to the present embodiment includes the power reception coil 22 that receives power from the power transmission device 10 and the secondary battery 27 that stores power from the power reception coil 22. The electronic apparatus 20 includes a charging control unit 24 that operates the first functional block 281 with the power from the secondary battery 27, supply the power from the power reception coil 22 in the second functional block 282 when the secondary battery 27 does not store the power from the power reception coil 22, and stop the supply of power from the power reception coil 22 to the second functional block 282 when the secondary battery 27 does not store the power from the power reception coil 22.

According to this configuration, when the secondary battery 27 is not charged with the power received from the power transmission device 10 while the operation of the first functional block 281 is maintained, the operation of the second functional block 282 is stopped, so that it is possible to minimize consumption of power stored in the secondary battery 27. Because a situation in which the stored power is insufficient for the operation of the electronic apparatus 20 is avoided as much as possible, the electronic apparatus 20 can operate more reliably.

Also, in the electronic apparatus 20, the charging control unit 24 supplies power from the secondary battery 27 to the second functional block 282 when the reception level of the power from the power reception coil 22 is lower than a predetermined reception level.

According to this configuration, when the reception level of the power received from the power transmission device 10 is low, power required for the operation of the second functional block 282 is acquired from the secondary battery 27, so that the operation of the second functional block 282 can be maintained.

Also, in the electronic apparatus 20, the charging control unit 24 supplies power from the power reception coil 22 to the load unit 29 that consumes power when the strength of power from the power reception coil 22 is greater than or equal to predetermined power and the second functional block 282 is not operated.

According to this configuration, it is possible to avoid overcharging because the remaining power is consumed without affecting the function of the electronic apparatus 20 when a reception level of power received from the power transmission device 10 is high and the second functional block 282 is not operated.

Also, in the electronic apparatus 20, a time at which the secondary battery 27 does not store power from the power reception coil 22 is a time at which the secondary battery 27 is fully charged.

According to this configuration, while the operation of the first functional block 281 is maintained, the operation of the second functional block 282 is stopped when the secondary battery 27 is fully charged, so that the consumption of power stored in the secondary battery 27 can be minimized. Because a situation in which the stored power is insufficient for the operation of the electronic apparatus 20 is avoided as much as possible, the electronic apparatus 20 can operate more reliably.

### Modified Examples

Although embodiments of the present invention have been described above with reference to the drawings, specific configurations are not limited to the embodiments, and design changes and the like may also be included without departing from the scope of the present invention. For example, the power reception unit 21 may be configured as a single power reception device.

Also, although an example in which the above-described power supply system 1 is a contactless power supply system which causes the power transmission device 10 to propagate AC power as electromagnetic waves and includes the power reception coil 22 that causes electromagnetic induction due to the propagated electromagnetic waves and receive AC power in the electronic apparatus 20 has been described, the present invention is not limited thereto. For example, the power supply system 1 may be a contact type power supply system. In this case, the power transmission device 10 may be provided with a power transmission terminal constituted of a conductor instead of a power transmission coil that supplies power. The electronic apparatus 20 may be provided with a power reception terminal constituted of a conductor instead of the power reception coil 22 as a power reception unit that receives power. The power transmission terminal and the power reception terminal are brought into electrical contact with each other, thereby forming a power line through which power from the power transmission device 10 is supplied to the electronic apparatus 20. The power transmission terminal and the power reception terminal may have a shape in which tips of the power transmission terminal and the power reception terminal are fitted to each other in mutually opposing positions so as to maintain contact with each other.

Also, although an example in which the communication unit of the power transmission device 10 and the communication unit 25 of the electronic apparatus 20 wirelessly transmit and receive data in the above-described power supply system 1 has been described, the present invention is not limited thereto. Data may be transmitted and received between the communication unit of the power transmission device 10 and the communication unit 25 of the electronic apparatus 20 in a wired manner. In this case, a power line formed by the power transmission terminal and the power reception terminal may be used as a transmission path for transmitting and receiving data.

Further, the above-described power transmission device 10 may supply externally supplied power. In this case, the power generation unit may be omitted in the power transmission device 10. Although an example in which the second functional unit is one second functional block 282 has been described, a plurality of second functional blocks may be included.

Also, the above-described embodiments can be performed according to the following aspects.

(1) A power reception device including: a power reception unit that receives power from a power transmission device; a secondary battery that stores the power from the power reception unit; and a control unit that operates a first functional unit with the power from the secondary battery, supplies the power from the power reception unit to a second functional unit in a case that the secondary battery stores the power from the power reception unit, and stops the supply of the power from the power reception unit to the second functional unit in a case that the secondary battery does not store the power from the power reception unit.

(2) The power reception device according to (1), wherein the control unit supplies the power from the secondary battery to the second functional unit in a case that strength of the power from the power reception unit is less than predetermined power strength.

(3) The power reception device according to (2), wherein the control unit supplies the power from the power reception unit to a load unit that consumes the power in a case that the strength of the power from the power reception unit is greater than or equal to the predetermined power strength and the second functional unit is not operated.

(4) The power reception device according to any one of (1) to (3), wherein a time when the secondary battery does not store the power from the power reception unit includes a time when the secondary battery is fully charged.

(5) The power reception device according to any one of claims 1) to (4), wherein the power reception unit is a power reception coil that receives power of an alternating current from the power transmission device.

(6) An electronic apparatus including: the power reception device according to any one of (1) to (5); the first functional unit; and the second functional unit.

(7) A power supply system including: a power transmission device; and the electronic apparatus according to (6).

Also, a part of the power transmission device 10, for example, the power transmission control unit, and a part of the electronic apparatus 20, for example, the charging control unit 24, may be implemented by a computer. In this case, a control function thereof may be implemented by recording a program for implementing the control function on a computer-readable recording medium and causing the computer system to read and execute the program recorded on the recording medium.

Also, a part or all of the power transmission device 10 and the electronic apparatus 20 in the above-described embodiment may be implemented as an integrated circuit such as a large scale integration (LSI). Each of the functional blocks of the power transmission device 10 and a part of the electronic apparatus 20 may be individually formed as a processor or a part or all thereof may be integrated into a processor. Also, a method of forming an integrated circuit is not limited to LSI, and may be implemented by a dedicated circuit or a general-purpose processor. Also, when the technology of an integrated circuit with which LSI is replaced emerges with the advancement of semiconductor technology, the integrated circuit based on the technology may be used.

### Industrial Applicability

As described above, a power reception device, an electronic apparatus, and a power supply system according to the present invention are useful for contactless power supply for an electronic apparatus.

### Description of Reference Symbols

1 . . . Power supply system

10 . . . Power transmission device

11 . . . Power transmission unit

20 . . . Electronic apparatus

21 . . . Power reception unit

22 . . . Power reception coil

23 . . . Power reception processing unit

24 . . . Charging control unit

25 . . . Communication unit

26 . . . Switching unit

27 . . . Secondary battery

281 . . . First functional block

282 . . . Second functional block

29 . . . Load unit

1. A power reception device comprising:
a power reception unit that receives power from a power transmission device;
a secondary battery that stores the power from the power reception unit; and
a control unit that
operates a first functional unit with the power from the secondary battery,
supplies the power from the power reception unit to a second functional unit in a case that the secondary battery stores the power from the power reception unit, and
stops the supply of the power from the power reception unit to the second functional unit in a case that the secondary battery does not store the power from the power reception unit.

2. The power reception device according to claim 1,
wherein the control unit supplies the power from the secondary battery to the second functional unit in a case that strength of the power from the power reception unit is less than predetermined power strength.

3. The power reception device according to claim 2,
wherein the control unit supplies the power from the power reception unit to a load unit that consumes the power in a case that the strength of the power from the power reception unit is greater than or equal to the predetermined power strength and the second functional unit is not operated.

4. The power reception device according to claim 1,
wherein a time when the secondary battery does not store the power from the power reception unit includes a time when the secondary battery is fully charged.

5. The power reception device according to claim 1,
wherein the power reception unit is a power reception coil that receives power of an alternating current from the power transmission device.

6. An electronic apparatus comprising:
the power reception device according to claim 1;
the first functional unit; and
the second functional unit.

7. A power supply system comprising:
a power transmission device; and
the electronic apparatus according to claim 6.
